(19) United States
(12) Patent Application Publication
(10) Pub. No.: US 2002/0120477 A1
(43) Pub. Date: Aug. 29, 2002

(54) System and method for supporting legally-compliant automated regulated services and/or products in connection with multi-jurisdictional transactions

(76) Inventor: Robert Jefferson Jinnett, New York, NY (US)

Correspondence Address: LeBoeuf, Lamb, Greene & MacRae, LLP, Suite 2000, 633 Seventeenth Street, Denver, CO, 80202, US

(21) Appl. No.: 10/072,289

(22) Filed: Feb. 7, 2002

Related U.S. Application Data
(60) Provisional application No. 60/267,556, filed on Feb. 9, 2001.

(51) Int. Cl. G06F 17/60

(52) U.S. Cl. 705/4; 709/229

(57) ABSTRACT

A system and method of supporting the provision of a wide variety of regulated services and products via a local and/or global communications network, is disclosed. Regulatory rules engines, which contains protocols on each jurisdiction's legal requirements applicable to the service/product transaction, implements protocols for making choice of law analyses, preemption analyses and hierarchical ranking of laws by stringency, in order to facilitate automated, real-time, multi-jurisdictional transaction processing over the network without violating the laws of any applicable jurisdiction.

### RELATED APPLICATION

This application claims priority to provisional application Serial No. 60/267,556 entitled, “Method and System for Providing Extranets Customized to the Laws of Individual Legal Jurisdictions as Technical Infrastructure to Support the Sales of Goods and Services over the Internet”, filed Feb. 9, 2001, which is hereby incorporated by reference.

### FIELD OF INVENTION

The present invention relates generally to the field of online administration of regulated services and/or products. More specifically, the invention relates to a system and method of supporting the provision of a wide variety of regulated-type services and products via local and/or global communications network, in a way that complies with each jurisdiction's legal requirements for the transaction and without violating the laws of any applicable jurisdiction.

### BACKGROUND OF INVENTION

Despite indications that the Internet is a useful marketing tool, a majority of insurance companies make minimal use of the Internet for the actual sales and/or administration of insurance. Presently, a majority of these companies use their websites primarily for informational purposes. A significant barrier to Internet use by most insurance companies (“insurers”) is myriad and differing state-by-state regulations. For instance, in the United States, each state prohibits the solicitation of insurance unless conducted by or on behalf of an insurance company properly licensed in the specific state. In addition, every state has laws requiring persons acting as “insurance agents, “insurance brokers” or “insurance producers” in each state to be licensed. And every state places certain limitations on the conduct of agents.

Further is the issue of what constitutes a legally binding insurance document online. Many states have laws and regulations governing the proper use of electronic signatures and records, as well as the procedures that must be followed in order to protect the privacy of consumer information. Generally, these laws and regulations vary not only from the federal to the state level, but also from state to state. Even where states adopt model laws for uniformity, the interpretation and application of those model laws may vary from state to state due to different state insurance department regulations.

For instance, federal and state legislative initiatives have adopted standards governing the execution and delivery of legally binding documents through the use of electronic signatures. These initiatives apply to the Internet. However, federal laws and some state laws differ on how to create valid electronic signatures and electronic records. Even where states have adopted a model law on the use of electronic signatures and records, such as the Uniform Electronic Transactions Act (UETA), insurance departments in the various states may interpret application of UETA to insurance transactions quite differently. It is expected that most states will adopt a more stringent standard for the electronic execution and delivery of insurance documents than for other types of contracts. However, the degree of stringency would likely vary from state to state.

Internet use by insurance companies also presents significant compliance issues particularly when companies are not licensed on a fifty-state basis. For example, traditional communications media, such as newspapers, radio and television, allow insurance companies and agents to direct their messages to targeted market(s), reaching only persons in the state(s) in which such companies/agents are licensed. However, Internet commerce may cause promotional or marketing materials created by an insurance company or agent to reach beyond target market(s) and to unintended recipients.

Additionally, many states require that insurance advertising be reviewed by their respective insurance departments. This creates an advertising content issue. For example, one web page insurance advertisement may comply with one state's insurance regulations but violate another state's advertising regulations. Once again, the argument follows that even though internet advertisements may not be intended for viewing by residents of all fifty states, these advertisements will nevertheless be accessible in all states by virtue of the technology. Consequently, issues such as unlawful solicitation and/or unlawful advertising assume special relevance for insurance companies and agents maintaining insurance websites, particularly insurance companies that are either not widely licensed or are not licensed at all.

Some state insurance regulators may view an insurance website as the functional equivalent of print advertising and telephone/fax communications. This situation raises a number of licensing issues for such insurance companies and/or agents. For instance, traditional insurance activities such as soliciting, binding of coverage, and collecting premiums, generally require state licensing. Thus, in order to be compliant, online insurance companies and agencies must ensure that appropriately licensed persons only communicate with individuals requesting information through the website for licensed insurance activities such as quotations, change of coverage and other similar matters.

The legal and/or regulatory environment in which insurance companies and/or agents operate mandates licensure in every state in which they are “doing business”. Whether an insurance company would be deemed to be “doing business” by maintaining an Internet website accessible in a state, depends on that state's “doing business” definition as well as on the state's view of its laws' applicability to electronic media. Hence, it is possible that accessibility of a website from any particular state could, in theory, be deemed sufficient to trigger that state's insurer licensing laws.

Another factor causing reluctance by insurance companies to employ Internet technology are privacy law issues. Pursuant to various federal and state laws, personal customer information must be maintained as confidential, and not used for marketing or other purposes without customer consent. For example, under the Health Insurance Portability and Accountability Act (“HIPAA”), health insurers, healthcare providers and healthcare clearinghouses deemed to be “covered entities” are required to adhere to stringent privacy standards.

However, other federal laws dealing with privacy, such as the Fair Credit Reporting Act (FCRA), and state privacy laws more protective of the privacy of individually identifiable health information than HIPAA are not pre-empted and must be followed as well. Accordingly, the U.S. privacy law landscape relating to confidential medical information is a patchwork quilt of multiple federal laws and the differing laws of the 50 states. Consequently, until a system can assure compliance with this complex and conflicting mix of federal and state laws on a timely basis, health insurers will continue to be reluctant to make full use of the Internet and electronic commerce for the marketing and administration of their existing health insurance portfolios.

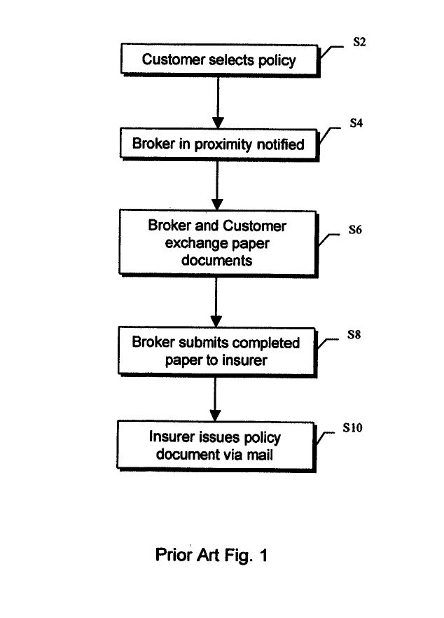

Due to the above-mentioned problems, there are a limited number of known insurance web sites. Such sites usually include disclaimers warning users that certain pages on the website are to be accessed by state residents only of the named state, and refer prospective consumers to a participating broker. A diagram of a conventional approach, which is generally limited to providing an electronic insurance quote on term life insurance, for instance, is shown in Prior Art FIG. 1.

The process begins when a consumer electronically selects an insurance policy (Step 2 or S2), that is already generally organized by policy type, such as term life, and cost. Consumer selection triggers notification to an insurance broker or agent in the closest, physical proximity to the consumer (S4). What follows is the traditional exchange of paper documents, back and forth between the broker and the consumer (S6), until the broker receives a completed, signed insurance application, at which point the broker forwards the completed (hard copy) document to the insurer (S8). The insurer then reviews the application and, if appropriate, underwrites and issues an insurance policy, which is usually mailed directly to the consumer (S10). The subsequent ongoing maintenance of the policy, including renewal, is supported by traditional paper methods.

There is therefore a need for a comprehensive and simple e-commerce-enabled solution for insurance companies and/or agents to market and administer, among other things, insurance products and services in a way that complies with the complex laws and regulations that are imposed on insurer's activities on a jurisdiction-by-jurisdiction basis.

### SUMMARY OF INVENTION

The present invention satisfies, to a great extent, the foregoing and other needs not currently satisfied by existing systems and methodologies. This is accomplished by configuring, on a jurisdictional basis, a communications network for processing regulated transactions that complies with substantially material applicable regulatory requirements, such as electronic signatures and records, privacy laws, advertising guidelines and the like, for that jurisdiction.

More specifically, in a preferred embodiment, the communications network comprises a plurality of regulatory rules engines, which contain rules and decision trees based on each applicable jurisdiction's legal requirements, and which implement protocols for making choice of law decisions, preemption decisions and hierarchical ranking of laws by stringency, all in order to facilitate automated, real-time transactions over the communications network without violating the laws of any applicable jurisdiction.

The choice of law rules engine principally identifies which jurisdictional law(s) apply to the particular transaction. The preemption rules engine principally identifies which jurisdictional law(s) preempt the laws of other applicable jurisdictional law(s). After choice of law and preemption analyses are completed, if multiple jurisdictional laws still apply to the transaction, a ranking rules engine is applied to the transaction. The ranking rules engine principally ranks the jurisdictional requirements in a hierarchy according to stringency so that the most stringent law(s) is/are applied; inherently, all less stringent but applicable jurisdictional laws are satisfied.

The communications network also comprises one or more databases, including a knowledge repository database for storing and processing transactions so that the above rules processes may be learned for substantially similar and/or specific transactions. In addition, the network may comprise one or more query databases containing relevant statutes, regulations, case opinions and other legal content. The query database(s) is/are accessible electronically through the network by the user in making business and/or legal decisions as to what laws apply and what transactions may be permitted. In one embodiment, the query databases do not support real-time automated transactions.

In an exemplary embodiment, the communications network is linked to a system comprising one or more extranets designed to facilitate electronic access and/or administration of regulated industry products and services in accordance with the jurisdictional bases for how those products and/or services are regulated.

For example, if industry regulations fall along geographic lines, as in the insurance industry, then the extranets of the present invention are preferably configured for user accessibility on a geographical basis, which may include along physical boundary lines. In these instances, the present invention encompasses configuring/using extranets to cover jurisdictions inside as well as outside the United States, on a state, regional, country or other jurisdictional basis, in order to create a secure network for servicing customers locally, regionally and/or worldwide.

In a preferred embodiment, each extranet may take the form of a private network or Internet site that users access in a secure manner through the use of passwords, Secure Sockets Layer (SSL) encryption, Virtual Private Network (VPN) technology, or other security technologies or procedures known in the art. It includes a database facility that maintains electronic records of messages and files transmitted over the secure network.

Alternatively and optionally, the extranet/network of the present invention may employ public key infrastructure asymmetric encryption, using the services of a trusted third party that acts as a certification authority. In yet another embodiment, network security measures may include other types of encryption or non-encryption technologies or procedures, such as symmetric encryption systems, biometrics, digital wrapping, smart cards and the like.

The extranets of the present invention are highly flexible and configured to accommodate each different jurisdiction's statutory and regulatory regimes of a desired industry in order to facilitate legal/regulatory compliance online. For example, as applied to insurance, each extranet/network may be configured to provide federal and local insurance laws/rules/regulations/mandates for all of the individual United States and territories, in order to facilitate legal/regulatory compliance by companies, agents and application service providers to the insurance industry in the relevant jurisdiction.

Additionally, each extranet allows for periodic updating as federal and state laws and regulations change. In this regard, compliance with each jurisdiction's insurance regulatory requirements for doing business over a global communications network, such as the Internet, is satisfied.

It is a feature and advantage of the present invention to provide a system and method for providing a communications network customized to the laws of individual legal jurisdictions, that serves as a technical infrastructure to support the administration and/or marketing of goods and services pertaining to a desired regulated industry over the Internet.

It is another feature and advantage of the present invention to provide a system and method for providing a communications network customized to the laws of individual legal jurisdictions, that serves as a technical infrastructure to support the administration and/or marketing of insurance goods and services over the Internet.

It is another feature and advantage of the present invention to provide a system and method for providing a communications network customized to the laws of individual legal jurisdictions, that complies with a jurisdiction's licensing laws and/or regulations for providing online insurance products and services.

It is another feature and advantage of the present invention to provide a system and method for providing a communications network customized to the laws of individual legal jurisdictions, that complies with a jurisdiction's privacy laws and/or regulations for providing online insurance products and services.

It is another feature and advantage of the present invention to provide a system and method for providing a communications network customized to the laws of individual legal jurisdictions, that complies with a jurisdiction's electronic signatures and electronic record-keeping requirements for providing online insurance products and services.

It is another feature and advantage of the present invention to provide a system and method for providing a communications network customized to the laws of individual legal jurisdictions, that complies with a jurisdiction's advertising laws and/or regulations for providing online insurance products and services.

It is another feature and advantage of the present invention to provide a system and method for providing a communications network customized to the laws of individual legal jurisdictions, that provides real time electronic access to online insurance products and services.

It is another feature and advantage of the present invention to provide a system and method for providing a communications network customized to the laws of individual legal jurisdictions, that is manageable and practical in its implementation.

It is another feature and advantage of the present invention to provide a system and method for providing a communications network customized to the laws of individual legal jurisdictions, that responds to new trends in the insurance industry as they emerge.

It is another feature and advantage of the present invention to provide a system and method for providing a communications network customized to the laws of individual legal jurisdictions, that supports existing insurance distribution systems.

It is another feature and advantage of the present invention to provide a system and method for providing a communications network customized to the laws of individual legal jurisdictions, that reduces the costs involved in the administration of insurance and renewal of policies.

It is another feature and advantage of the present invention to provide a system and method for providing a communications network customized to the laws of individual legal jurisdictions, that is adaptable to meet the needs of other regulated industries, such as the financial services industry.

It is important to recognize that the present invention allows users to use the communication network, which may include the Internet, for a full range of online insurance products and services, because it solves existing regulatory/legal obstacles to electronic marketing of insurance. These obstacles include licensing, advertising, and procedural requirements, such as those relating to the execution and delivery of documents/files. In addition, the present invention allows access to a broad range of online insurance products and services without having to use brokers, if desired by users and permitted by applicable law.

Optionally and alternatively, the present invention also allows use of the Internet together with traditional broker-based distribution systems to maintain online-based links between retail customers and brokers, between brokers and insurers, and between insurers and the customers. These links or relationships are maintained in a way that is designed to be compliant with local and federal laws and regulations.

Moreover, the present invention is of value to all insurance industry participants, including virtual insurance companies and application service providers. It also allows insurers to streamline operations and reduce paper use costs, not only in new sales but also in maintenance of existing, issued policies.

Preferably, once an extranet is created for each jurisdiction, such as an individual state of the United States, for example, each state-by-state network in compliance with applicable regulatory insurance requirements allows insurers and its brokers to use digital signatures and other e-commerce tools to issue policies and renewals. In one embodiment, one or more databases are maintained at multiple locations with a server maintained in each state. The databases store all of the participating insurers' insurance policies, renewals, communications with insureds, and the like. Optionally, “mirror” copies of the databases may be provided to the insurers for their internal use.

It is not imperative that a server be maintained in each state, unless required to be maintained in a state for regulatory reasons, such as compliance with a regulation of a state department of insurance. The network of the present invention is configured for maximum flexibility. One or more databases may each be housed together with or remotely from one or more servers throughout the network. The overriding concern is seamless and real time access by users of the system.

In one aspect of the present invention, a method for providing electronic access to services and/or products subject to government regulation, is disclosed. The method includes the steps of: providing one or more databases of legal requirements governing each service and/or product; providing one or more rules engines for establishing a hierarchy of how to apply legal requirements for each service and/or product; creating one or more networks linking each database and rules engine such that each service transaction and each product transaction is customized with the legal requirements relevant to the service/product transaction; and outputting a transaction result. The legal requirements may be organized on a jurisdiction-by-jurisdiction basis.

The method further includes a step of providing one or more sets of protocols for establishing a hierarchy of how to apply information. Organization of the protocols may be provided on a jurisdiction-by-jurisdiction basis. Similarly, in the step of creating one or more networks, customization of each service/product transaction data occurs with the legal requirements of a desired jurisdiction that is/are relevant to each service/product transaction.

The step of creating one or more networks, further includes a step of configuring each network to: allow use of permitted technologies as desired, and to bar use of prohibited technologies as desired; and to include access to individuals and/or entities that participate in providing each service/product.

The method further includes the step of providing security for each database and network to facilitate secure access and data transmission. This step includes authenticating the identity of a user and/or file and/or transaction. It may also include employing technology to protect against interception of any information during data transmission. The method further includes the steps of: providing security through a certification authority; and providing security that is user-definable.

The services/products of the present invention is applicable to the insurance and financial services industries.

As to the step of providing one or more databases of legal requirements, it includes providing jurisdiction-specific content on federal laws, state laws, country laws, regional laws, online access and administration requirements, licensing requirements, privacy requirements, general online requirements, advertising requirements, and electronic signatures and records requirements governing each service/product.

Additionally, the step of providing one or more databases of legal requirements, further includes the steps of: identifying a governmental jurisdiction governing each service/product; identifying each governmental unit issuing legal mandates governing each service/product; and compiling these legal mandates or requirements applicable to each service/product for each desired jurisdiction.

Compiling information on each service/product is a step included in the step of providing database information on each service/product.

A jurisdiction includes a state, country or member country, region, territory, commonwealth and/or a district.

In another aspect of the present invention, a system configured to provide customized insurance services and products in real time, is disclosed. The system comprises one or more networks that performs the steps of: determining a transaction for processing; identifying either a user's jurisdiction or a primary jurisdiction relevant to the transaction; detecting user input data; applying to the transaction, one or more laws of a jurisdiction identified as either the user's jurisdiction or the primary jurisdiction relevant to the transaction; and outputting a transaction result that customizes the user data and application of each applicable law of the jurisdiction identified as the user's or the primary jurisdiction relevant to the transaction.

In yet another aspect of the present invention, a communications network used for providing real time access to customized insurance services, is disclosed. The network comprises: one or more databases for storing legal and/or regulatory data governing an insurance transaction; one or more databases for storing insurance products data and/or insurance services data; one or more rules engines for applying a hierarchy of rules regarding at least one of choice of law, preemption and ranking of laws protocols, to each insurance transaction; one or more processors for processing data transmitted over the network; and a data management system for managing integration/customization of insurance transaction data and the hierarchy of rules with the legal and/or regulatory data governing the insurance transaction.

In yet another aspect of the present invention, in a method for providing electronic access to regulated services and/or products, a system of protocols, which is imposed on one or more transactions involving regulated services and/or products, is disclosed. The system comprises the steps of: identifying one or more legal jurisdictions applicable to each transaction; identifying by a choice of law analysis pertinent laws from the identified jurisdictions that are applicable to each transaction; among the pertinent laws, identifying by a preemption analysis which laws substantially preempt other of the pertinent laws; among all remaining laws outside the pertinent laws, ranking of substantially all remaining laws by level of stringency; applying, in accordance with the ranking, one or more laws to each transaction such that one or more stringently ranked laws applied to a transaction substantially satisfies substantially all less stringently ranked applicable laws; and outputting a transaction result.

In the preferred embodiment of this aspect of the invention, databases store data (i.e. legal and/or regulatory, insurance services and/or products) either by a desired category, or on a jurisdiction-by-jurisdiction basis.

The network also includes a network of insurance brokers and/or agents and/or application service providers identified by licensed jurisdiction. The network also includes security measures for enabling the network to be secure; these measures may include encryption and/or non-encryption technologies. The network may further include use of a certification authority for authenticating identity of a user and/or file and/or transaction. Optionally and alternatively, authentication may occur within a public key infrastructure.

There has been outlined, rather broadly, the important features of the invention in order that the detailed description thereof that follows may be better understood, and in order that the present contribution may be better appreciated. Additional features of the invention will be described hereinafter.

In this respect, before explaining at least one embodiment of the invention in detail, it is to be understood that the invention is not limited in its application to the details of construction and to the arrangements of the components set forth in the following description or as illustrated in the drawings.

The invention is capable of other embodiments and of being practiced and carried out in various ways. For example, one embodiment falling within the scope of the claims may be described as a method of providing online investment products and services in compliance with jurisdictional requirements. The method includes, in part, the steps of providing a data communications network for transmitting electronic inquiries by users requesting one or more investment products and services; and processing those inquiries in a manner that links the user to the appropriate extranet having a jurisdiction of legal relevance to the requested transaction. Alternatively and optionally, a user's inquiry may be processed in a manner that links the user to the appropriate extranet having a jurisdiction of legal relevance to the geographic location of the user.

Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out several purposes of the present invention. Therefore, it is important that the claims be regarded as including such equivalent constructions insofar as they do not depart from the spirit and scope of the present invention.

The above features and/or advantages of the invention, together with other aspects of the invention, along with the various features of novelty that characterize the invention, are pointed out with particularity in the claims appended to and forming a part of this disclosure.

### BRIEF DESCRIPTION OF PREFERRED EMBODIMENTS

FIG. 1 is a flow chart describing a conventional approach limited to offering electronic insurance quotes.

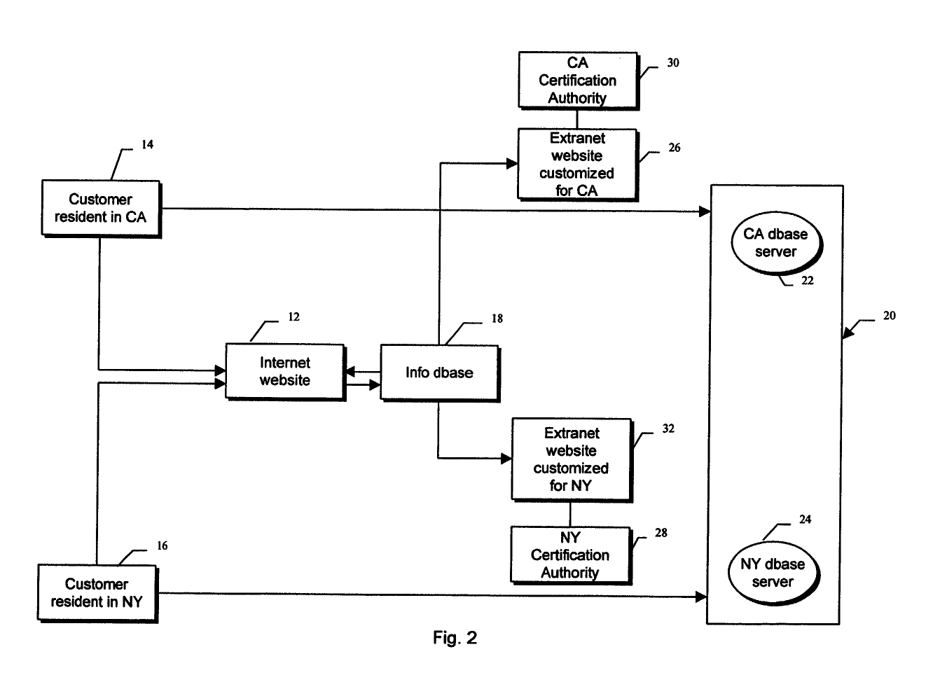

FIG. 2 shows an operational process flow diagram of the system of linked, jurisdiction-specific networks in accordance with one embodiment of the present invention.

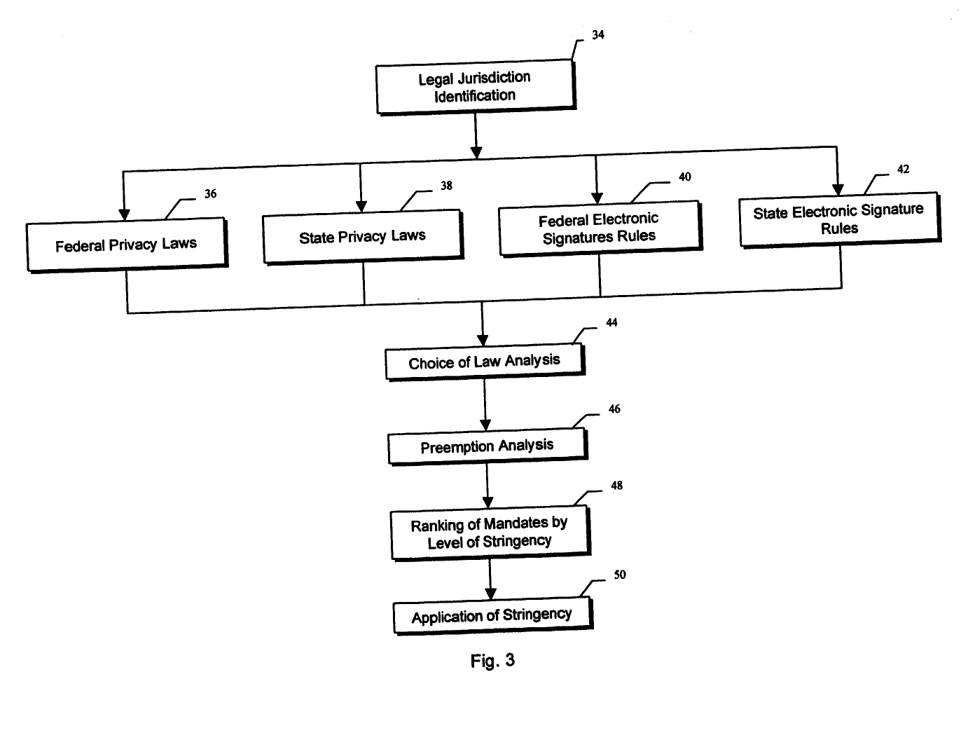

FIG. 3 is a block diagram showing an exemplary embodiment of a decision tree describing application of a plurality of rules engines to a multi-state transaction.

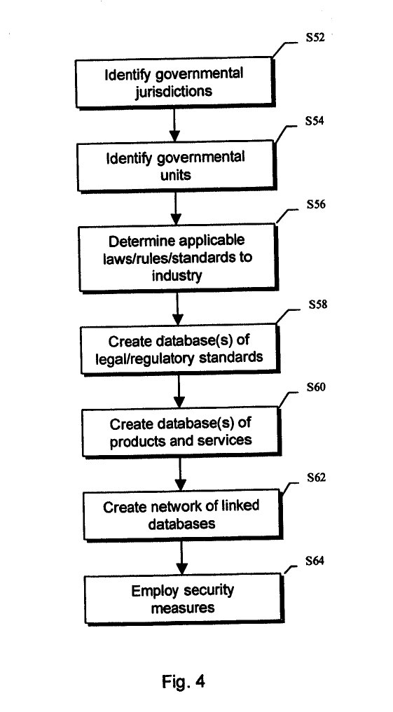

FIG. 4 is a flow chart describing a method of providing online insurance products and/or services in accordance with the embodiment of FIG. 2.

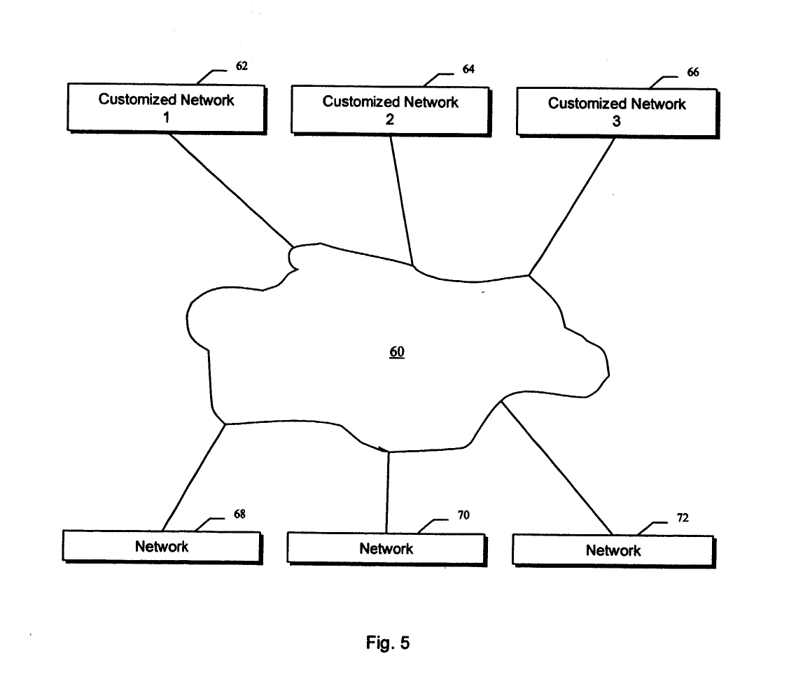

FIG. 5 is an illustration of the architecture combining the internet for use in the present invention in accordance with one embodiment.

### NOTATIONS

In the Detailed Description Section that follows, the description is presented, in part, in terms of program procedures executed on a computer or network of computers. For completeness, it is to be understood that the instant invention is equally applicable to any customary network of computers, of which the Internet is an example. Such networks of computers, for example, include a standard communications protocol, such as Transmission Control Protocol/Internet Protocol (TCP/IP), Open Systems Interconnection (OSI) protocol, User Datagram Protocol (UDP), Wireless Application Protocol (WAP), and/or Bluetooth wireless communications protocol, or any other network-type protocol, local and/or global.

The procedural descriptions and representations herein made are generally used by those skilled in the art to most effectively convey the substance of their work to others skilled in the art. A procedure is generally conceived to be a self-consistent sequence of steps leading to a desired result. Each step may involve physical manipulation of physical quantities, which takes the form of magnetic signals capable of being stored, transmitted, combined, compared and otherwise manipulated. For reasons of common usage, these signals may be referred to as bits, values, elements, characters, terms or the like.

Additionally, the manipulations performed herein, such as providing, obtaining, allowing, maintaining, creating, are often referred to in terms that may be commonly associated with mental operations performed by a human. Human capability is not necessary, or desirable in most cases, in the operations forming part of the present invention; the operations are machine operations. Machines useful for performing the operations of the present invention include general-purpose computers or such similar electronic devices.

The present invention also relates to a system for performing these operations. This system may be specially constructed for its required purpose or it may comprise a general-purpose computer as selectively activated or reconfigured by a computer program stored in a computer.

### DETAILED DESCRIPTION OF PREFERRED EMBODIMENT

The present invention relates to a system of linked communications networks comprising one or more extranets designed to facilitate electronic access, marketing and/or administration of regulated industry products and services on a jurisdictional basis. For convenience, the present invention will be discussed with reference to the insurance industry. However, the present invention has application to other regulated industries, such as the financial services industry.

Using the insurance industry in the United States as an example, the present invention is not based on a blanket fifty-state communications network model, but rather is customized to fit jurisdiction-by-jurisdiction legal requirements. In other words, in a preferred embodiment, one or more communications networks is configured for each state. The network preferably stores and/or processes a regulated transaction that complies with all the applicable regulatory requirements of concern for that state, such as regulations concerning electronic signatures and records, privacy laws, advertising guidelines and any other insurance and/or non-insurance regulations pertaining to the particular transaction. These extranets are preferably linked together and tied into one or more websites in accordance with protocols that allow the linking to comply with jurisdictional requirements.

An example of how the present invention operates to allow regulated transaction processing through Internet-accessible sites and databases to an insurer, its brokers and its insureds residing within each covered states, is best described with respect to FIG. 2. In this embodiment, an Internet website 12 of the insurer is preferably operational, with one or more consumers 14, 16 residing in California, and New York, respectively, having access to the site 12. The insurer's website 12 interfaces with one or more databases 18 containing insurance policy and other information. In another embodiment, user access is obtained through a master website, rather than through a site 12 of the insurer.

The system of the present invention is capable of handling customer inquiries generally falling into two categories: status inquiries and transactional inquiries.

Status-type inquiries from consumers 14, 16 are transmitted directly to a database query facility, which houses one or more jurisdictional database servers, in this instance the California and New York database servers 22, 24, respectively. The database query facility 20 maintains electronic records of consumer messages and transactions in individual databases conforming to applicable state requirements.

Optionally and alternatively, the database query facility may be remotely deployed throughout the network rather than the housing one or more servers at a single location. In this embodiment, the databases may be maintained at one or more data processing facilities 20, with a server maintained at a facility in individual states if required by the regulators of those states, and with information being collected within regional servers, where permissible. One advantage to this arrangement is that maintenance of electronic databases of all the participating insurers' insurance policies, renewals, and correspondences would make such information easily available for audits by state insurance departments.

In addition, the facility 20 may optionally be deployed on a regional basis, essentially consolidating several area servers in order to serve a desired region.

Transactional-type inquires are not as straightforward as status inquires. For instance, once a consumer 14 accesses an insurance company's website 12 for policy information and indicates a desire to perform a transaction (e.g. purchase an insurance policy, change a beneficiary, terminate a policy, etc.), the consumer 14 is prompted for his or her state of residence or key jurisdiction of legal relevance to the desired transaction.

If the consumer 14 selected California to be the jurisdiction of relevance, the transaction is routed from the insurance company's website 12, via database 18, to an extranet site 26 customized to match the legal regulatory requirements of the applicable jurisdiction; namely, California. Similarly, if the consumer 16 selected New York as the key jurisdiction, the transaction is routed from website 12 to extranet site 28 containing New York laws. Transition to the extranet may be apparent to the user or seamless.

The three elements being customized are: (a) the communications network over which the transaction is transmitted; (b) the database(s) and/or database facilities, which stores an electronic record of transactions; and (c) the encryption, password or other security features applicable to the transaction.

In those jurisdictions where a certification authority (or other authentication procedures conforming to the jurisdiction's requirements) is required to issue certificates authenticating the digital signatures used in connection with the insurance electronic files, the network of the present invention is optionally configurable to provide a certification authority 30, 32 associated with each respective extranet 26, 28. Notably, the communications link between each of the extranets 26, 28 and its associated certification authority 30, 32 employ security measures conforming to the security requirements of the respective extranet 26, 28; namely, California and New York, respectively.

Alternatively and optionally, the present invention is adaptable to the use of an insured's existing digital signature vendor rather than requiring issuance of new public keys and/or private keys by a new vendor. Although a primary database of all electronic records transmitted over the secure network is maintained, the insurer may also obtain electronic copies of all files residing in the database(s) for the insurer's own internal review and use. The present invention may also accommodate authentication of files transmitted over the secure network through security measures other than digital signatures, such as a combination of digitally watermarked documents and PIN numbers or passwords, in order to authenticate electronic records and identify consumer records.

Also noteworthy is the point that if the insurance laws of a particular jurisdiction permit the use of digital signatures and signature dynamics (e.g. based on biometrics signature software only) to create electronic signatures, but does not permit the use of a symmetric encryption system, the extranet of the present invention is configurable to allow use of permitted technology/ies and bar usage of prohibited technology/ies, as necessary and/or as desired. Similarly, if the insurance laws of a particular jurisdiction permit insurance policies to be in electronic form, but prohibits electronic cancellations of policies, the extranet of the present invention is adaptable to be configurable accordingly.

As described above, a series of extranets allow for compliance with material applicable regulatory requirements, and allow insurance companies and brokers to use digital signatures and other e-commerce tools in connection with issuance of policies and renewals. Instead of attempting to devise procedures that would satisfy the requirements of insurance departments of multiple states, the use of single jurisdiction extranets means that only compliance with one jurisdiction's laws and/or the approval of one jurisdiction's insurance department would be required for such intrastate activity.

As also indicated above, the present invention is flexible to changing regulations. For example, if one state adopts a privacy law that is more stringent that the privacy standards set forth in HIPAA, then the (new) supplemental privacy regulation is used to update or reconfigure the appropriate state's extranet.

With respect to the maintenance and transmission of electronic records, the preferred embodiment of the present invention employs Secure Sockets Layer (SSL) encryption, or a comparable encryption standard, in order to protect against interception of any information during data transmission. The files themselves are preferably protected by levels of encryption ranging up to 128 bits or higher, depending on the company's designation of levels of protection required. For a very high level of protection, digital signature technology may be used.

Referring now to FIG. 3, there is shown an exemplary embodiment of a decision tree describing application of a plurality of rules engines to a multi-state transaction, such as a multi-state insurance transaction. As depicted, application begins with box 34, identifying one or more legal jurisdictions that may be applicable to the desired transaction. Factors may include the location of each of the insured, health insurer, hospital and the clearinghouse. The rules engine(s) identify/identifies the sets of laws and/or regulations of each jurisdiction that may be involved or mapped in an insurance transaction. These laws may include federal privacy laws 36, such as HIPAA and the Fair Credit Reporting Act (FCRA), state privacy laws 38, federal electronic signature regulations 40, and state electronic signature regulations 42.

The choice of law analysis 44 indicates an identification of laws from the identified jurisdictions that may apply to the transaction. The rules engine applies protocols in order to reduce the number of jurisdictional laws that must be reviewed using a choice of law analysis 44. For example, if for purposes of the legal issues raised by the transaction, the residence of an insured is not relevant, the laws of the state of the insured's residence are excluded from the analysis.

The following is another example of a choice-of-law protocol. In this instance, the parties to the insurance transaction are a health insurer and a hospital where the legal issue is which insurance law governs record retention by a health insurer. The choice-of-law protocol operates to exclude, from the underlying transaction, the laws of any state that does not have a “nexus” to the parties and that otherwise is not specified as applying to the transaction, such as pursuant to a choice of law provision in a contract between the health insurer and the hospital. The group of applicable state laws may be further reduced if the legal issue in question, for example, is controlled by a state's insurance department regulations, and the only state in which the health insurer does business is the state of New York. In this instance, New York State law and the New York State Insurance Department's regulations are selected as controlling by the choice-of-law protocol.

Next, referring now back to FIG. 3, the rules engine manipulates the laws remaining after the choice-of-law analysis and applies protocols thereto to substantially eliminate laws that have been preempted by other laws in the group under consideration. In other words, the preemption analysis 46 concerns an identification of laws that may preempt any of the other laws. If a federal law in the group preempts all state laws in the group, then all state laws are eliminated from the group.

The following is an example of a preemption analysis protocol of the present invention that is invoked in order to determine whether federal law, such as a HIPAA privacy regulation, state law or both, applies to a regulated transaction. A beginning inquiry is whether a provision of state law imposes a standard, requirement or implementation specification that is also included within the privacy regulation. If not, both state law and the federal privacy regulation must be complied with.

On the other hand, if state law imposes a standard, the next determination is whether it is impossible to comply with both state and federal requirements. If not, both state law and the federal privacy regulation must be complied with.

On the other hand, if the state law presents an obstacle to the accomplishment of the purposes of the privacy regulation, the next determination is dual-fold: whether the state law provision relates to the privacy of health information and whether it is more stringent than the standard, requirement or implementation specification adopted under the federal privacy regulation. If so, the state law provision must be complied with.

Otherwise, the next determination is whether the state law provision provides for the reporting of disease or injury, child abuse, birth or death, or for the conduct of public health surveillance, investigation or intervention. If so, the state law provision must be complied with.

Otherwise, the next determination is whether the provision of state law requires a health plan to report, or provide access to, information for the purpose of management audits, financial audits, program monitoring and evaluation, or the licensor or certification of facilities or individuals. If so, the state law provision must be complied with.

Otherwise, the next determination is whether the Secretary of the U.S. Department of Health and Human Services has determined that the state law provision is necessary to prevent fraud, to ensure appropriate regulation of insurance and health plans, for state reporting on health care delivery or costs, for the purpose of service a compelling need related to public health, safety or welfare, or has as its principal purpose the regulation of controlled substances. If so, the state law provision must be complied with. If not, the federal privacy regulation must be complied with.

Finally, with respect to FIG. 3, ranking 48 of the laws by level of stringency, and application 50 of the ranked laws (or subset of laws) that is most stringent and which, if imposed, satisfies substantially all less stringent applicable laws, completes the decision tree. For instance, if more than one law remains in the group after the preemption analysis 46, all remaining laws in the group are ranked hierarchically from the least stringent to the most stringent. The most stringent law is applied, provided that the most stringent law satisfies substantially all less stringent laws in the group.

The decision tree of FIG. 3 operates in conjunction with the query databases containing legal/regulations source materials (e.g., laws, regulations, case opinions) in that based on the legal content of the query databases, one or more rules engines are created. Alternatively, the rules engines may be created independently. In addition, the rules engines are preferably developed using Unified Modeling Language (UML) or UML-based software for creating business templates based on the legal content, such as the HIPAA Privacy Rule requirements. Alternatively and optionally, another modeling lanugage may be used.

After development of the business templates, individuals involved in the business or insurance transaction, such as a health insurer or hospital, are identified, afterwhich a use case is developed. For example, a use case may be the request by a health insurer to a hospital for a patient's full medical record. Under the HIPAA Privacy Rule, a hospital must conduct a “minimum necessary” analysis prior to disclosing protected health information, unless it determines that the entity requesting the information is a “covered entity” under HIPAA. A decision logic corresponding to the use case is developed. Here, for instance, the decision logic is developed whereby in instances where an insurer requests patient information from the hospital, a business rule requires a minimum analysis prior to disclosure unless the health insurer is a covered entity. If the hospital determines that the health insurer is a covered entity, the minimum necessary analysis is not conducted. In this regard, the rules engine is based on an “if x, then do y” type of logic and comprises such decision trees for a particular law, such as HIPAA.

In another application of the query databases and rules engines, for example, a master query database is maintained and updated so as to keep the legal content current. The master query database is preferably accessible over a local (e.g. an extranet) or global communications network. A user or subscriber determines which transaction processing gives rise to the legal issues covered by the master query database and rules engines, and links its computer system, at appropriate transactional nodes, to the rules engine.

Accordingly, each transaction is routed to the rules engine for analysis. The rules engine either approves the transaction as in compliance with applicable law(s), or prohibit the transaction as in violation of the law(s). If approved for further processing, the transaction proceeds as depicted in FIG. 3.

If a transaction is identified as being violative of the applicable law(s) or, alternatively, if the rules engine is unable to determine compliance or non-compliance, transaction processing is halted and a message is sent notifying the user or system operator of its suspended status and/or the details why. At this juncture, the user consults the master query database and/or other relevant sources in order to identify what additional steps are necessary to bring the transaction into compliance. Once the legal issue is resolved for a particular transaction, a knowledge repository database maintains a record of the transaction for future reference by the rules engine, in order to avoid flagging and/or suspending a future similar transaction.

Referring now to FIG. 4, there is shown a flow chart of a method for providing online services and/or products in accordance with the embodiment of FIG. 2. For the most part, these services and/or products are subject to governmental regulations. For consistency, the methodology of FIG. 2 will be discussed with respect to the insurance industry which, like the financial services industry, is subject to government regulation.

A beginning step in the process is identification of the governmental jurisdiction(s) in which the industry, in general, and the insurer, more specifically, operate(s) (S52). For the insurer, these jurisdictions may optionally include one or more locations where the insurer has prospective customers, or where the insurer contemplates expansion.

Once each governmental jurisdiction is identified, the next step is to identify appropriate governmental units having legal authority over the desired transactions to be performed (S54). With respect to the insurance industry, for example, one step is to identify the governmental unit(s) (e.g. federal government and relevant state government) issuing legal mandates over the use of electronic commerce in insurance transactions.

Subsequently, for each federal and/or relevant state jurisdiction that has been identified above, the laws governing use of electronic commerce in insurance transactions (e.g. network, database facility and security) are identified, and protocols are established as to how those laws will be applied (S56).

For example, where U.S. federal standards for any of the three elements preempt a state standard, the federal standard governs. Where a state standard is not preempted but exceeds the federal standard, the state standard would apply. In the event that two or more states have matching standards in terms of the three elements relating to network, database and security features, one extranet may be used the transaction in the matching states. This information is compiled into one or more databases, preferably on a jurisdictional and/or industry basis (S58), and preferably employing a data manipulation language.

Next, at least one additional database is created; a database of the products and/or services to be offered online (S60). In the insurance industry, an insurance company may create an electronic database of its sales materials, forms, applications and other documents that is accessible using Hypertext Markup Language (HTML), Extensible Markup Language (XML), or other Internet protocols. At this juncture, all of the above databases are linked together in a way that provides electronic access to insurance information and services that is customized to the legal/regulatory standards of a desired locale, area or jurisdiction (S62).

In a preferred embodiment, this network of linked databases is configurable to include access to one or more networks that links the relevant individuals who participate in the regulated industry. For example, in the insurance arena, a private network may be established by linking all the insurance brokers of one insurance company within one/each state (e.g. New York). Alternative linking arrangements may also be established as desired.

The network of linked databases is also preferably configured with security measures to authenticate files and consumers (S64). In one embodiment, a consumer may execute an agreement whereby the consumer agrees to use digital signatures to communicate with the insurer as well as to accept the insurer's digital signature instead of a handwritten signature. In addition, a digital signature is issued to the consumer, against a computer check of the consumer's driver license and/or other identification, in order to verify consumer identity.

After execution and delivery of the first executed paper agreement, all further communications between the insurer/insurance company and insured/consumer may be performed electronically over the network, with the broker, insurer and insured accessing the extranet site directly. Alternatively, digital signatures may be verified by a certification authority using public key infrastructure procedures.

FIG. 5 is an illustration of internet use in the present invention in accordance with one embodiment. The internet architecture 60 may be combined with, for example, one or more networks 62, 64, 66 containing one or more databases of legal/regulatory standards applicable to the desired transaction to be performed. In the insurance industry, for example, each network 62, 64, 66 may contain customized laws governing use of electronic commerce in insurance transactions for one or more jurisdictions.

The internet architecture 60 may also be combined with one or more networks 68, 70, 72 containing one or more databases of information on the products and/or services offered by one or more insurers. Users may access or use the networks 62, 64, 66, 68, 70, 72 through differing access methods. As illustrated in this embodiment, the databases are used to store content, data and the like, and are accessible by a computer system accessing each network 62, 64, 66, 68, 70, 72, and/or using a local area network or the internet 60.

The many features and advantages of the present invention are apparent from the detailed specification. The above description is intended by the appended claims to cover all such features and advantages of the invention, and all suitable modifications and equivalents fall within the spirit and scope of the invention. For completeness, the above description and drawings are only illustrative of preferred embodiments and are not intended to limit the invention to the exact construction and operation herein illustrated and described.

What is claimed is:

1. A method of providing electronic access to at least one of services and products that are subject to government regulation, said method comprising the steps of:
(a) providing one or more databases of legal requirements governing said at least one of services and products;
(b) providing one or more rules engines for establishing a hierarchy of how to apply legal requirements for each said at least one of services and products;
(c) creating one or more networks linking each database and rules engine such that each service transaction and each product transaction is customized with the legal requirements relevant to said each service transaction and each product transaction; and
(d) outputting a transaction result.

2. The method according to claim 1, wherein the step of providing one or more databases of legal requirements, further includes a step of providing said legal requirements on a jurisdictional basis.

3. The method according to claim 1, wherein the step of providing one or more rules engines, further including a step of providing one or more legal requirements on a jurisdictional basis.

4. The method according to claim 1, wherein the steps of providing one or more databases and one or more rules engines, each further includes a step of providing one or more sets of protocols for establishing a hierarchy of application of information.

5. The method according to claim 1, wherein the step of creating one or more networks, further includes a step of configuring each network such that each service transaction and each product transaction is customized according to the legal requirements of a desired jurisdiction relevant to said each said service transaction and each said product transaction.

6. The method according to claim 1, further including a step of providing security for each database and network to facilitate secure access and data transmission.

7. The method according to claim 1, further including a step of providing security through a certification authority.

8. The method according to claim 6, wherein said step of providing security includes a step of authenticating identity of at least one of a user, a file and a transaction.

9. The method according to claim 6, wherein said step of providing security includes a step of employing technology to protect against interception of any information during data transmission.

10. The method according to claim 1, further including a step of providing security that is user-definable.

11. The method according to claim 1, wherein said at least one of services and products relate to insurance.

12. The method according to claim 1, wherein said at least one of services and products relate to finance.

13. The method according to claim 1, wherein the step of providing one or more databases of legal requirements, includes a step of providing one or more query databases of at least one of federal and state laws governing each service and each product on a jurisdiction basis.

14. The method according to claim 1, wherein the step of providing one or more databases of legal requirements, includes a step of providing one or more query databases of at least one of country and regional laws governing each service and each product on a jurisdiction basis.

15. The method according to claim 1, further including a step of providing one or more databases of jurisdiction-specific legal requirements governing electronic access and administration for said each service transaction and said each product transaction.

16. The method according to claim 1, wherein the step of providing one or more databases of legal requirements, further includes a step of providing one or more query databases of jurisdiction-specific licensing requirements governing said each service transaction and said each product transaction.

17. The method according to claim 1, wherein the step of providing one or more databases of legal requirements, further includes a step of providing one or more query databases of jurisdiction-specific privacy requirements governing said each service transaction and said each product transaction.

18. The method according to claim 1, wherein the step of providing one or more databases of legal requirements, further includes a step of providing one or more query databases of jurisdiction-specific electronic requirements governing said each service transaction and said each product transaction.

19. The method according to claim 1, wherein the step of providing one or more databases of legal requirements, further includes a step of providing one or more query databases of jurisdiction-specific advertising requirements governing said each service transaction and said each product transaction.

20. The method according to claim 1, wherein the step of providing one or more databases of legal requirements, further includes a step of providing one or more query databases of jurisdiction-specific requirements concerning electronic signatures and records governing said each service transaction and said each product transaction.

21. The method according to claim 1, wherein the step of creating one or more networks, further includes a step of configuring each network to allow use of permitted technologies as desired, and to bar use of prohibited technologies as desired.

22. The method according to claim 1, wherein the step of providing one or more databases of legal requirements, further includes a step of identifying a governmental jurisdiction governing said each service transaction and said each product transaction.

23. The method according to claim 1, wherein the step of providing one or more databases of legal requirements, further includes a step of identifying each governmental unit issuing legal mandates governing said each service transaction and said each product transaction.

24. The method according to claim 1, wherein the step of providing one or more databases of legal requirements, further includes a step of compiling legal requirements applicable to said each service transaction and said each product transaction for each desired jurisdiction.

25. The method according to claim 1, wherein the step of providing one or more databases of information, further includes a step of compiling information on said each service transaction and said each product transaction.

26. The method according to claim 1, wherein the step of creating a network, further includes a step of configuring the network to include access to at least one of individuals and entities that participate in providing said each service transaction and said each product transaction.

27. The method according to claim 2, wherein said jurisdiction is a state.

28. The method according to claim 2, wherein said jurisdiction is at least one of a country and member country.

29. The method according to claim 2, wherein said jurisdiction is a region.

30. The method according to claim 2, wherein said jurisdiction is a territory.

31. The method according to claim 2, wherein said jurisdiction is a commonwealth.

32. The method according to claim 2, wherein said jurisdiction is a district.

33. In a system configured to provide customized insurance services and products in real time, the system comprising one or more networks performing the steps of:
(a) determining a transaction for processing;
(b) identifying at least one of a user's jurisdiction and a primary jurisdiction relevant to said transaction;
(c) detecting user input data;
(d) applying to said transaction, one or more laws of a jurisdiction identified as said user's jurisdiction or said primary jurisdiction that pertains to said transaction; and
(e) outputting a transaction result that customizes said user data and application of said one or more laws of a jurisdiction identified as said user's jurisdiction or said primary jurisdiction that pertains to said transaction.

34. A communications network used for providing real time access to customized insurance services, said network comprising:
(a) one or more databases for storing at least one of legal and regulatory data governing an insurance transaction;
(b) one or more databases for storing at least one of insurance products data and insurance services data;
(c) one or more rules engines for applying a hierarchy of rules regarding at least one of choice of law, preemption and ranking of laws protocols, to each said insurance transaction;
(d) one or more processors for processing data transmitted over said network; and
(e) a data management system for managing integration of insurance transaction data and said hierarchy of rules with said at least one of legal and regulatory data governing said insurance transaction.

35. The communications network according to claim 34, wherein said one or more databases for storing at least one of legal and regulatory data, stores at least one of said legal and regulatory data by a desired category.

36. The communications network according to claim 34, wherein said one or more databases for storing one of legal and regulatory data, stores at least one of said legal and regulatory data by jurisdiction.

37. The communications network according to claim 34, wherein said one or more databases for storing at least one of insurance products data and insurance services data, stores at least one of said insurance products data and insurance services data by a desired category.

38. The communications network according to claim 34, further including a network of insurance brokers in a desired jurisdiction.

39. The communications network according to claim 34, further including a network of insurance brokers of a desired corporate entity.

40. The communications network according to claim 34, further including a network of insurance agents in a desired jurisdiction.

41. The communications network according to claim 34, further including a network of insurance agents of a desired corporate entity.

42. The communications network according to claim 34, further including a network of insurance application service providers in a desired jurisdiction.

43. The communications network according to claim 34, further including security measures enabling said network to be secured.

44. The communications network according to claim 43, wherein said security measures include at least one of encryption and non-encryption technologies.

45. The communications network according to claim 34, further including a certification authority for authenticating at least one of an identity of a user, a file and a transaction.

46. In a method for providing electronic access to at least one of regulated services and products, a system of protocols is imposed on one or more transactions involving said at least one of regulated services and products, said system comprising the steps of:
(a) identifying one or more legal jurisdictions applicable to each transaction;
(b) identifying by a choice of law analysis pertinent laws from the identified jurisdictions that are applicable to each transaction;
(c) among said pertinent laws, identifying by a preemption analysis which laws substantially preempt other of said pertinent laws;
(d) among all remaining laws outside said pertinent laws, ranking of substantially all said remaining laws by level of stringency;
(e) applying, in accordance with said ranking, one or more laws to each transaction such that one or more stringently ranked laws applied to a transaction substantially satisfies substantially all less stringently ranked applicable laws; and
(f) outputting a transaction result.
